(19) United States
(12) Patent Application Publication
(10) Pub. No.: US 2016/0171218 A1
(43) Pub. Date: Jun. 16, 2016

(54) MEMORY DEVICE AND SCRIPT-EXECUTION CONTROL METHOD

(71) Applicant: KABUSHIKI KAISHA TOSHIBA, Tokyo (JP)

(72) Inventor: Kuniaki ITO, Funabashi Chiba (JP)

(73) Assignee: KABUSHIKI KAISHA TOSHIBA, Tokyo (JP)

(21) Appl. No.: 14/848,298

(22) Filed: Sep. 8, 2015

(30) Foreign Application Priority Data
Dec. 11, 2014 (JP) 2014-251095

(51) Int. Cl. G06F 21/57; H04L 9/32

(52) U.S. Cl. CPC G06F 21/572; H04L 9/3236

(57) ABSTRACT

A memory device according to an embodiment includes a calculator and a storage unit. The calculator encrypts a first script to a first hash key. The storage unit stores therein a second hash key obtained by encrypting a second script. The calculator compares the first hash key with the second hash key in order to control execution of the first script.

### CROSS REFERENCE TO RELATED APPLICATIONS

This application is based upon and claims the benefit of priority from the prior Japanese Patent Application No. 2014-251095, filed on Dec. 11, 2014, the entire contents of which are incorporated herein by reference.

### FIELD

Embodiments relate to a memory device and a script-execution control method.

### BACKGROUND

An SD card having a wireless communication function can directly access a cloud site by its own wireless communication function, without relying on the wireless communication function of a host device. Such access to a cloud site is performed by executing a script stored in an SD card by a script processor of the SD card.

The script here has user-friendliness such that compiling is not required. On the other hand, because a source code of the script cannot be concealed, the source code is likely to be tampered by a third party.

Therefore, in a conventional SD card having a wireless communication function, there has been a problem that a script thereof is tampered by a third party, and a script unintended by the user of the SD card is executed.

### BRIEF DESCRIPTION OF THE DRAWINGS

FIG. 1 is a block diagram showing a memory system 1 according to an embodiment;

FIG. 2 is a flowchart showing an operation example of a memory device 2 in the memory system 1 in FIG. 1; and

FIG. 3A is a schematic diagram showing an operation example when a first script is a legitimate script, FIG. 3B is a schematic diagram showing an operation example when the first script is a tampered script, and FIG. 3C is a schematic diagram showing an operation example when the first script is an updated legitimate script.

### DETAILED DESCRIPTION

A memory device according to an embodiment includes a calculator and a storage unit. The calculator encrypts a first script to a first hash key. The storage unit stores therein a second hash key obtained by encrypting a second script. The calculator compares the first hash key with the second hash key in order to control execution of the first script.

Embodiments will now be explained with reference to the accompanying drawings. The present invention is not limited to the embodiments.

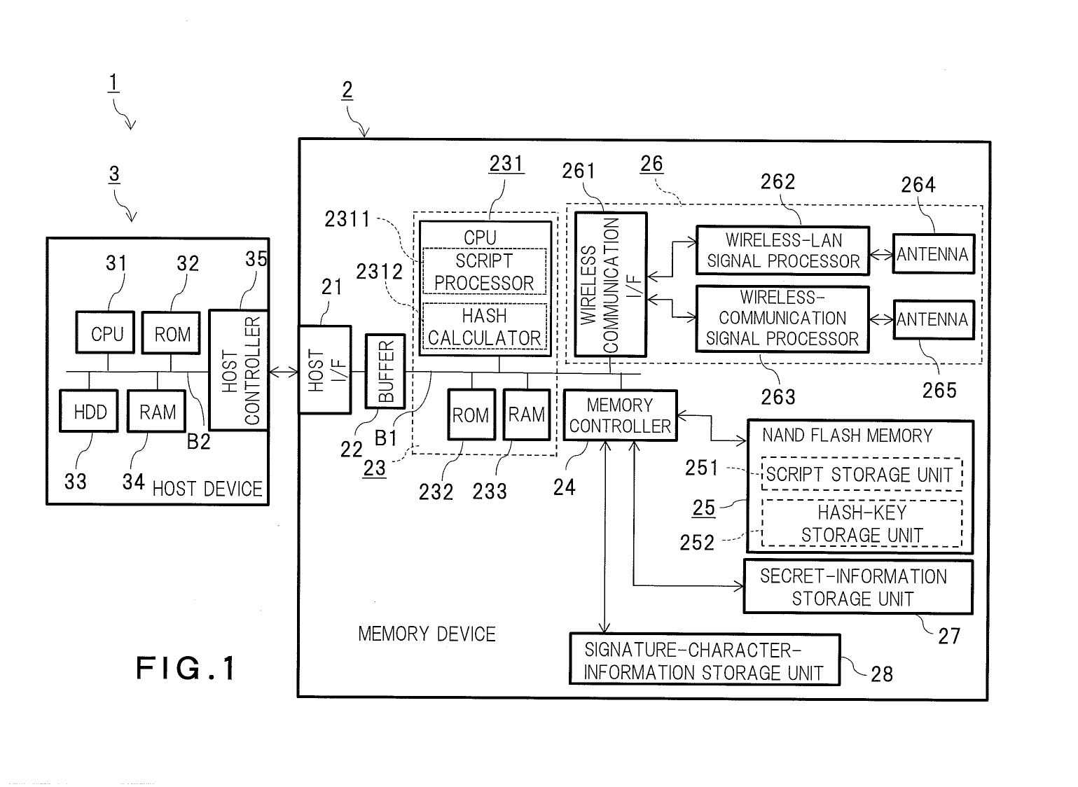

FIG. 1 is a block diagram showing a memory system 1 according to an embodiment. The memory system 1 includes a memory device 2 and a host device 3. The memory device 2 is, for example, an SD card having a wireless communication function. The host device 3 is, for example, a computer terminal such as a digital camera, a mobile phone, a smartphone, or a personal computer.

The memory device 2 is connected to the host device 3, and is supplied with power from the host device 3. The memory device 2 performs a process according to access from the host device 3.

As shown in FIG. 1, the memory device 2 includes a host interface (I/F) 21, a buffer 22, and a main controller 23. The host interface 21 connects the host 1 and the memory device 2 with each other. The memory device 2 includes a memory controller 24, an NAND flash memory 25 (storage unit), a communication unit 26, a secret-information storage unit 27, and a signature-character-information storage unit 28. The NAND flash memory 25 includes a script storage unit 251 and a hash-key storage unit 252.

The main controller 23 includes a CPU 231 (calculator), a ROM 232, and a RAM 233. The communication unit 26 includes a wireless communication interface (I/F) 261, a wireless-LAN signal processor 262, a wireless-communication signal processor 263, and antennas 264 and 265. The CPU 231 includes a script processor 2311 and a hash calculator 2312.

The buffer 22, the CPU 231, the ROM 232, the RAM 233, the memory controller 24, and the wireless communication interface 261 are connected to a common bus B1. The buffer 22 is connected to the host interface 21.

The memory controller 24 is connected to the NAND flash memory 25, the secret-information storage unit 27, and the signature-character-information storage unit 28. The wireless communication interface 261 is connected to the wireless-LAN signal processor 262 and the wireless-communication signal processor 263. The wireless-LAN signal processor 262 is connected to the antenna 264, and the wireless-communication signal processor 263 is connected to the antenna 265.

The host interface 21 can be connected to the host device 3. The host interface 21 performs reception of a command and transfer of data between the host device 3 and the host interface 21, in a state of being connected to the host device 3. For example, the host interface 21 receives data to be written (such as still pictures or motion pictures) from the host device 3, with write access from the host device 3.

The buffer 22 temporarily stores therein data to be processed by the memory device 2. For example, the buffer 22 temporarily stores therein data to be written from the host device 3.

The NAND flash memory 25 is a user data region to which read/write access from outside can be made freely. For example, data to be written is written in the NAND flash memory 25 according to write access from the host device 3.

The memory controller 24 performs write and read of data with respect to the NAND flash memory 25, the secret-information storage unit 27, and the signature-character-information storage unit 28. For example, the memory controller 24 performs write of data to be written according to the write access from the host device 3 and read of data to be transmitted (such as still pictures or motion pictures) with respect to the NAND flash memory 25 according to a transmission command from the host device 3.

The communication unit 26 connects the memory device 2 to an external network. The external network is, for example, a cloud site (a server on the Internet) that supports HTTP and HTTPS.

For example, the memory controller 24 transmits data to be transmitted, which is read from the NAND flash memory 25, to the wireless communication interface 261. The wireless-LAN signal processor 262 transmits data to be transmitted acquired from the wireless communication interface 261 to the cloud site via the antenna 264 through a wireless LAN system.

The communication unit 26 can connect the memory device 2 also to a communication counterpart other than the external network. Specifically, the wireless-communication signal processor 263 acquires data to be transmitted, which is read from the NAND flash memory 25 by the memory controller 24, via the wireless communication interface 261. The wireless-communication signal processor 263 transmits the acquired data to be transmitted to a portable terminal (for example, a smartphone) via the antenna 265 by a communication method other than wireless LAN (for example, near field communication).

The main controller 23 controls the entire operation of the memory device 2. The CPU 231 executes firmware stored in the ROM 232, thereby enabling control by the main controller 23. The firmware supports a predetermined API (Application Programming Interface).

Here, the API is a regulation defining procedures and data formats for invoking and using a certain function of a computer program and data to be managed from other external programs. A short program for invoking a part of the functions of the firmware can be described according to the API. Because the entire firmware does not need to be programmed, the development cost of the firmware can be reduced when description according to the API is used.

As the short program according to the API, there is a script described in a script language. The script omits or automates processes such as conversion to a machine language and creation of an executable file. Therefore, the script is a program that can be executed immediately after describing the source code thereof.

In consideration of the user-friendliness of the script, in the present embodiment, a first script is stored in the script storage unit 251 in order to invoke a part of the functions of the firmware. The script processor 2311 can execute the first script. As a result, the part of the functions of the firmware can be performed in response to the invoking from the script processor 2311.

The first script is, for example, character string data. The script processor 2311 can invoke the firmware that performs a secret function of accessing an external network by executing the first script, thereby performing the function.

The first script may have contents to acquire secret information to be used for the access to the external network. As the external network accessed by using secret information, for example, there is a cloud site that adopts an OAuth system. The secret information is information to be concealed, which is used for the access to the external network, and is, for example, an access token in which a user ID and a password are encrypted.

The secret information to be used for the access to the external network is stored in the secret-information storage unit 27. Therefore, when the first script has contents to acquire the secret information, the first script becomes a script that can access the secret-information storage unit 27.

If the first script is a script that can access the secret-information storage unit 27, the script processor 2311 can access the secret-information storage unit 27 to acquire the secret information by executing the first script. Further, the script processor 2311 can acquire permission for access from the cloud site by transmitting the acquired secret information to the cloud site through the communication unit 26.

In this manner, as the script processor 2311 executes the first script to acquire secret information, the memory device 2 can access the external network by using its own wireless communication function. For example, the memory device 2 can upload data to be transmitted written in the NAND flash memory 25 to a cloud site, according to a transmission command from the host device 3.

However, if execution of the first script is not restricted, a third party who has accessed the script storage unit 251 may tamper the first script, and as a result, the third party may illegally acquire the secret information based on the tampered first script. Further, the third party may illegally access data uploaded by a user by misusing the illegally acquired secret information.

Therefore, the memory device 2 includes the hash-key storage unit 252, the signature-character-information storage unit 28, and the hash calculator 2312 in order to prevent that the first script is tampered and an unintended script is executed.

Specifically, the hash-key storage unit 252 stores therein a second hash key obtained by encrypting a second script.

The second script matches a legitimate first script, which is not tampered (that is, authentic). On the other hand, the second script is different from the tampered first script.

The second hash key is information uniquely corresponding to the second script, and is irreversible information that can hardly decode the second script from the second hash key. The second hash key can be a bit string having a predetermined length based on, for example, a cryptographic hash function (a one-way function).

Further, the second hash key can be a hash key written in the NAND flash memory 25 together with the legitimate first script. Write of the second hash key and the legitimate first script can be performed at a manufacturing stage of the memory device 2, or at an update stage thereof.

If the first script and the second hash key can be updated, the user-friendliness of the script such that the script can be flexibly modified matched with the purpose thereof can be ensured. Update of the first script and the second hash key can be performed through communication with a server using the communication unit 26 or communication with a server using the communication function of the host device 3 (for example, a personal computer). Update of the first script and the second hash key can be accompanied by update of signature character information described later.

The signature-character-information storage unit 28 stores therein signature character information capable of encrypting the second script to the second hash key. The signature-character-information storage unit 28 is a secret region that cannot be accessed for read and write from outside.

Specifically, the signature-character-information storage unit 28 cannot be accessed for read and write via either the host interface 21 or the communication unit 26. The signature character information is, for example, character string data.

The hash calculator 2312 encrypts the first script to the first hash key based on the signature character information. That is, the hash calculator 2312 performs hash calculation based on the signature character information and the first script, thereby calculating the first hash key. The first hash key is information uniquely corresponding to the first script.

A specific mode of the hash calculation is not particularly limited, so long as it is the same as a method that can encrypt the second script to the second hash key based on the signature character information, and, for example, the signature character information and the first script can be input to a hash function of a predetermined algorithm.

If the hash calculation is performed with respect to the legitimate first script, the calculated first hash key matches the second hash key. On the other hand, if the hash calculation is performed with respect to a tampered first script, the calculated first hash key is different from the second hash key.

The script processor 2311 restricts execution of the first script, if the first hash key is different from the second hash key. For example, the script processor 2311 does not perform the API capable of accessing the secret-information storage unit 27 included in the first script. Further, for example, the script processor 2311 can be configured so as not to execute the entire first script.

Therefore, the memory device 2 can prevent the tampered first script from being executed. Accordingly, the memory device 2 has an effect of preventing the secret information from being acquired illegally. Details of operations of the memory device 2 are described later.

As shown in FIG. 1, the host device 3 includes a CPU 31, a ROM 32, a hard disk drive 33 (HDD), a RAM 34, and a host controller 35. These constituent elements 31 to 35 are connected to each other via a bus B2.

The CPU 31 controls the entire host device 3. The ROM 32 stores therein firmware to be executed by the CPU 31. The RAM 34 is an operating area of the CPU 31. The hard disk drive 33 stores therein various types of data such as still pictures and motion pictures. The host controller 35 performs access to the memory device 2.

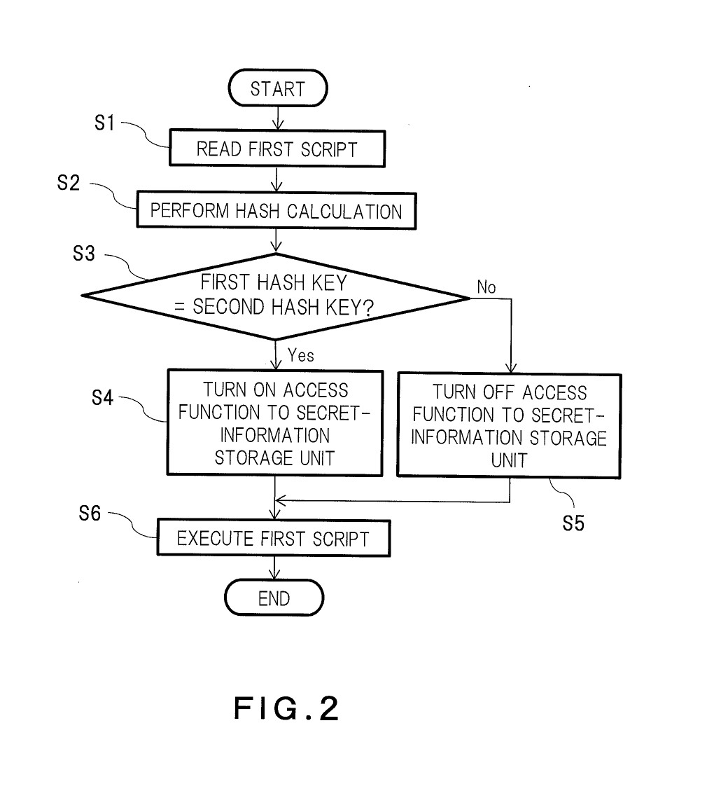

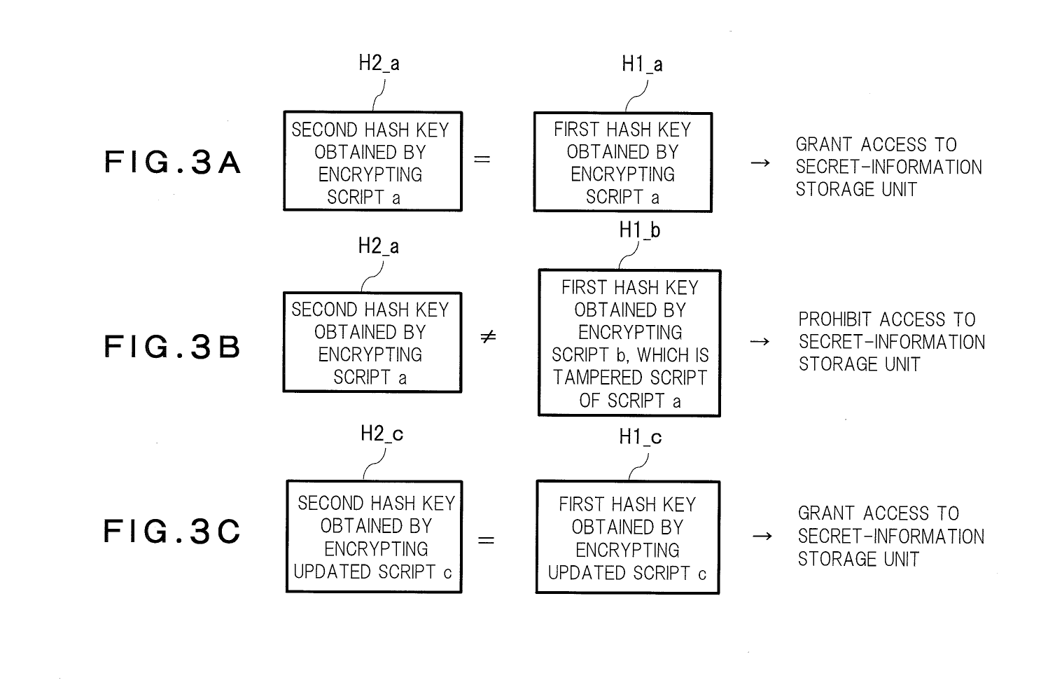

FIG. 2 is a flowchart showing an operation example of the memory device 2 in FIG. 1, that is, a script-execution control method. FIGS. 3 are diagrams showing operation examples of the memory device 2 in FIG. 1. An example of the operation of the memory device 2 is described with reference to FIGS. 2 and 3.

As shown in FIG. 2, the script processor 2311 reads a first script from the script storage unit 251 (Step S1). Readout of the first script can be started when the script processor 2311 executes firmware according to the access from the host device 3.

Next, the hash calculator 2312 performs hash calculation based on the first script and signature character information to encrypt the first script to a first hash key (Step S2).

The script processor 2311 then compares the first hash key calculated by the hash calculation with a second hash key stored in the hash-key storage unit 252, to determine whether these keys match each other (Step S3).

Subsequently, if the first hash key matches the second hash key (YES at Step S3), the script processor 2311 turns on (validates) a function of accessing the secret-information storage unit 27 (script part) described in the first script (Step S4).

Meanwhile, if the first hash key does not match the second hash key (NO at Step S3), the script processor 2311 turns off (invalidates) the function of accessing the secret-information storage unit 27 (script part) described in the first script (Step S5).

Subsequently, the script processor 2311 executes the first script in a range where execution thereof is not restricted (in a valid range) (Step S6).

The script processor 2311 can determine if an access function to the secret-information storage unit 27 is included in the first script after readout of the first script (Step S1). In this case, if the access function is included in the first script, the script processor 2311 can shift to the hash calculation (Step S2), and if the access function is not included in the first script, the script processor 2311 can immediately shift to the execution of the first script (Step S6).

For example, as shown in FIG. 3A, if a second hash key H2_a is a hash key obtained by encrypting a script a, while the first script is a legitimate script a, a first hash key H1_a obtained by hash calculation matches the second hash key H2_a. In this case, the script processor 2311 can perform the access function to the secret-information storage unit 27 in the first script a.

On the other hand, as shown in FIG. 3B, if the second hash key H2_a is a hash key obtained by encrypting the script a, while the first script is a script b obtained by tampering the legitimate script a, a first hash key H1_b obtained by hash calculation does not match the second hash key H2_a. In this case, the script processor 2311 cannot perform the access function to the secret-information storage unit 27 in the first script a.

Further, as shown in FIG. 3C, there are cases where the second hash key is updated to H2_c obtained by encrypting a script c. When the second hash key is to be updated to H2_c, the first script is also updated to the script c simultaneously.

As shown in FIG. 3C, if the first script is an updated legitimate script c, a first hash key H1_c acquired by hash calculation matches the updated second hash key H2_c. In this case, the script processor 2311 can perform the access function to the secret-information storage unit 27 in the updated first script c.

As described above, according to the present embodiment, because the access to the secret-information storage unit 27 is controlled according to a comparison result between the first hash key and the second hash key, execution of a script unintended by a user can be restricted.

The first script whose execution is restricted only needs to be the tampered first script, and is not limited to a script that is tampered to access to the secret-information storage unit 27. Further, the content whose execution is restricted in the first script is not limited to the access to the secret-information storage unit 27, and for example, can be different according to the tampering mode of the first script.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A memory device comprising:
a calculator that encrypts a first script to a first hash key; and
a storage unit that stores therein a second hash key obtained by encrypting a second script, wherein
the calculator compares the first hash key with the second hash key in order to control execution of the first script.

2. The memory device of claim 1, wherein when the first hash key is different from the second hash key, the calculator restricts execution of the first script.

3. The memory device of claim 1, further comprising a signature-character-information storage unit that stores therein signature character information capable of encrypting the second script to the second hash key, wherein
the calculator encrypts the first script to the first hash key based on the signature character information.

4. The memory device of claim 2, further comprising:
a communication unit; and
a secret-information storage unit that stores therein secret information to be used for access of the communication unit to a network, wherein
when the first hash key is different from the second hash key, the calculator does not execute a script capable of accessing the secret-information storage unit included in the first script.

5. The memory device of claim 1, wherein
the storage unit stores therein the first script, and
the memory device further comprises an interface that permits read and write access to the storage unit from outside.

6. The memory device of claim 3, wherein the signature-character-information storage unit cannot be accessed for read and write from outside.

7. The memory device of claim 6, further comprising a communication unit, wherein
the signature-character-information storage unit cannot be accessed for read and write from outside through the communication unit.

8. The memory device of claim 6, further comprising an interface that permits read and write access to the storage unit from outside, wherein
the signature-character-information storage unit cannot be accessed for read and write from outside through the interface.

9. The memory device of claim 1, wherein
the first hash key is information uniquely corresponding to the first script, and
the second hash key is information uniquely corresponding to the second script.

10. A script-execution control method comprising:
storing a second hash key obtained by encrypting a second script in a storage unit;
encrypting a first script to a first hash key; and
comparing the first hash key with the second hash key in order to control execution of the first script.

11. The method of claim 10, comprising restricting execution of the first script, when the first hash key is different from the second hash key.

12. The method of claim 10, further comprising:
storing signature character information capable of encrypting the second script to the second hash key in a signature-character-information storage unit; and
encrypting the first script to the first hash key based on the signature character information.

13. The method of claim 11, further comprising:
storing secret information to be used for access of a communication unit to a network in a secret-information storage unit; and
not executing a script capable of accessing the secret information included in the first script, when the first hash key is different from the second hash key.

14. The method of claim 10, further comprising storing the first script in the storage unit, wherein
the storage unit can be accessed for read and write from outside through an interface.

15. The method of claim 12, wherein the signature-character-information storage unit cannot be accessed for read and write from outside.

16. The method of claim 12, wherein the signature-character-information storage unit cannot be accessed for read and write from outside through a communication unit.

17. The method of claim 12, wherein the signature-character-information storage unit cannot be accessed for read and write from outside through an interface.

18. The method of claim 10, wherein
the first hash key is information uniquely corresponding to the first script, and
the second hash key is information uniquely corresponding to the second script.
